(19) United States
(12) Patent Application Publication
(10) Pub. No.: US 2015/0185712 A1
(43) Pub. Date: Jul. 2, 2015

(54) Windows based Gourmet Maestro Software commands a hardware controller to do the cooking process

(71) Applicant: William E. Byrne, Sunnyvale, CA (US)

(72) Inventor: William E. Byrne, Sunnyvale, CA (US)

(21) Appl. No.: 14/588,380

(22) Filed: Dec. 31, 2014

Related U.S. Application Data
(60) Provisional application No. 61/922,787, filed on Dec. 31, 2013.

(51) Int. Cl. G05B 11/36; G05D 23/19

(52) U.S. Cl. CPC G05B 11/36; G05D 23/19

(57) ABSTRACT

The invention is a cooking device and method that includes a editable computerized recipe database to improve and more efficiently manage and control, in real-time; many types of cooking or heating processes, including the cooking of food. It can also be used for the carrying out of general purpose Temperature-time heating experiments. The user has access to a wide range of controllable temperature-time pair choices included in the recipe databases. Each of these controllable specific temperature-time pairs, produce a unique final product. It provides recipe management and controls and records all cooking/heating experiments.

### CROSS-REFERENCES TO RELATED APPLICATIONS

This is the Non-provisional Application to Provisional Application 61/922,787 filed Dec. 31, 2013.

### FIELD OF THE INVENTION

This device refers to the field of injection of Windows based Gourmet Maestro Software commands a hardware controller to do the cooking process.

### BACKGROUND OF THE INVENTION

Chefs and experimenters use an enormous amount of Recipe Temperature-Time data to produce consistently high quality products, as a result of their cooking process or experimentation.

Because of the myriad of temperature-time choices available for cooking or experimenting, there exists a need to efficiently use, create and manage and store the results of this voluminous amount of data.

There remains room for improvement in the current device.

### SUMMARY OF THE INVENTION

The invention is a cooking device and method that includes an editable computerized recipe database to improve and more efficiently manage and control, in real-time; many types of cooking or heating processes, including the cooking of food. It can also be used for the carrying out of general purpose Temperature-time heating experiments. The user has access to a wide range of controllable temperature-time pair choices included in the recipe databases. Each of these controllable specific temperature-time pairs, produce a unique final product. It provides recipe management and controls and records all cooking/heating experiments.

### BRIEF DESCRIPTION OF DRAWINGS

Without restricting the full scope of this invention, the preferred form of this invention is illustrated in the following drawings in which:

FIG. 1 is a schematic view of the system and device; and

FIG. 2 is a screen shot of a recipe page;

FIG. 3 is a block diagram of the temperature control;

FIG. 4 is displays the controller; and

FIG. 5 displays the Anti Windup setup.

### DETAILED DESCRIPTION OF THE PREFERRED EMBODIMENT

There are a number of significant design features and improvements incorporated within the invention.

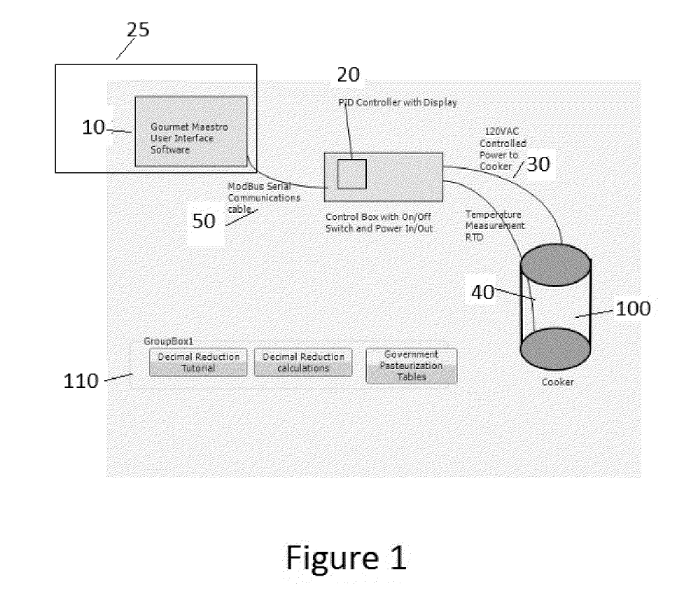

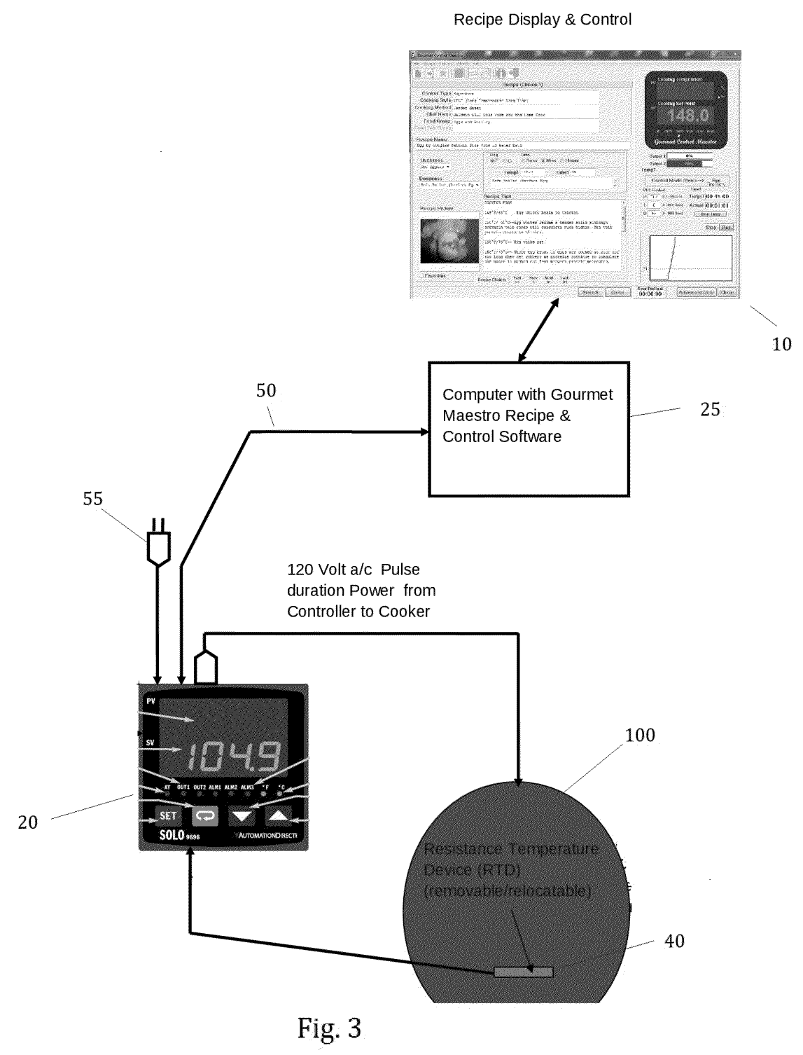

This invention referred to as Gourmet Maestro. As shown in a schematic view in FIG. 1 and a block diagram in FIG. 3, it has a editable computerized recipe database to improve and more efficiently manage and control, in real-time; many types of cooking or heating processes, including the cooking of food or carrying out general purpose Temperature-time heating experiments. The user has access to a wide range of controllable temperature-time pair choices included in our recipe database's 110. Each of these controllable specific temperature-time pairs, produce a unique final product. Gourmet maestro provides recipe management and controls and records all cooking/heating experiments. The databases are stored on electronic storage means and media and can be accessed through a computer or microprocessor 25.

The current invention involves significant “extra-solution activity.” The invention including a machine and requires implementation of the method steps, by and through the computer 25. The computer 25 executes the Gourmet Software 10 that relates to activities that are central to the purpose of the method invented. A partial list of these activities are:

Recipe Management, including Creation/Using/Importing/Exporting/Cooking Communications through a network to command or Interrogate the Temperature controller.

The core of the invention is the system architecture which includes the Cooker, the temperature Controller, the network (wireless or Hardwired) and the Gourmet Maestro Windows based Recipe Database and Control software. The computer manages the various processes required to access, edit or use a recipe, including computations for calibration, Communications with the PID temperature Controller and to manipulations of the information in the Recipe database and acts upon user inputs that are entered via the user man/machine interface.

The database 110 allows a Chef or experimenter to create/search for numerous database categories, including cooker type, chef/experimenter's name, Food or Chemical main and sub groups. The database 110 is stored, in the preferred embodiment, in a electronic storage medium and the system is run electronically using a computering device 25 by changing the electronic data in said computering device 25.

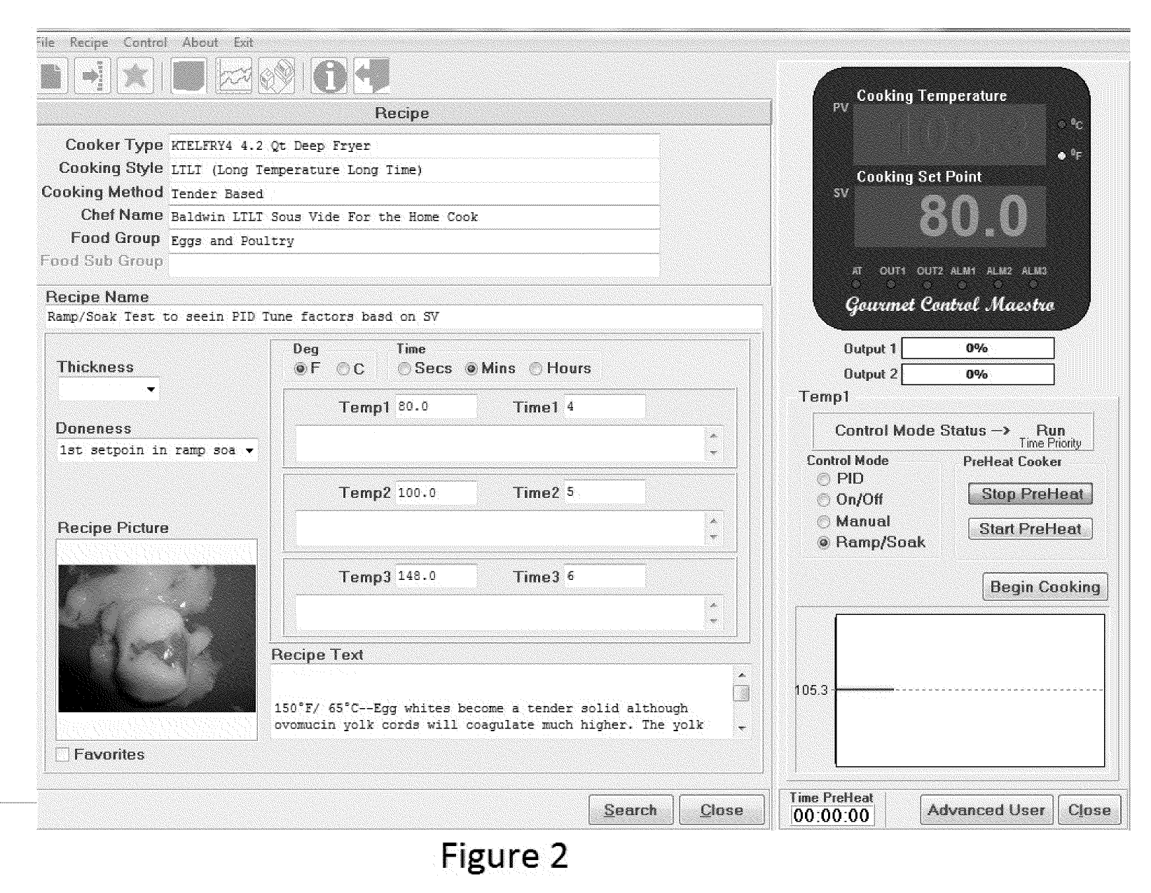

The invention which in the preferred embodiment is compatible with the Windows operating system also allows the user to enter/edit a textual description such as List of Ingredients, directions to carry out the experiment and permits the user to also use Multiple temperature time pair choices per recipe, record a photo of each experiment and add textual notes for each unique & individual temperature and time control point. This can be done through a windows compatible device. Please note other devices and input systems can be used. A proposed screen shot is shown in FIG. 2.

Gourmet Maestro use a Proportional Integral Derivative controller 20 as a method of providing consistent and accurate temperature control in the commercial world of process control. The use of a PID controller 20 replaces the more primitive On-Off controllers using in most cooker/heating vessels 100 available.

The invention also allows the user to use a 3 point calibration system for those applications/experiment which need even better accuracy.

Gourmet Maestro is uniquely suited to the high accuracy requirement of Sous Vide Cooking Sous Vide chefs have developed many temperature-time pair profiles to satisfy the requirements of different levels of doneness. Its database 110 allows the user to access and cook using our one click access to any of 100's of Temperature-Time database recipes built into the software. The user is allowed to add to this database 110 of temperature time pairs by a user friendly recipe entry/editing system. The software is stored and processes on electronic storage means and run on a microprocessor or processing chip changing the electronic medium.

PID control 20 historically required that the User manually upset the process and then measure the response of the temperature to this upset, and using visual recorded data from this response, to calculate P,I & D tuning factors which are entered into the controller. The magnitude of these P,I, & D tuning factors match the thermal dynamics of the cooker 100 to the controllers' characteristics, resulting in faster recovery and more stable/accurate control of temperature.

Gourmet Maestro also allows the user to automatically tune numerous kinds of cooking or heating vessels 100. The value of the 3 tuning factors depends on the current temperature Set point, and the thermal dynamic heat transfer characteristics of a specific Cooker/vessel. The invention allows a user off-line, to fill a vessel with the amount of water to be used in a future experiment. The user then enters into that Cooker's tuning table, the different temperatures for which different tuning temperatures are required.

After the user starts the tuning process, Gourmet Maestro heats the cooker 100 to the 1st temperature in the tuning table and automatically and either by using hardware in the PID controller 20 or by Computer software 10, upsets the process by changing the Set point. The PID hardware Controller or computer software 10 then observes the response of the Temperature as a result of this upset and calculates the P,I & D tuning factors for that temperature set point and records theses values next to the temperature in the tuning table. The automatic process then heats the Cooker 100 to the next temperature in the tuning table and repeats the calculations. This Automatic Profile Tuning process results in a tuning table with numerous Set point temperatures with their associated Tuning factors. The user can then use this cooker 100 anytime in the future knowing that when he changes the set point temperature, the Gourmet Software will recognize any change in set point and scan the tuning table; selecting the closest tuning factor s in the table that are the closest match to the users Set Point temperature. This assures the user that the Cooking system always uses the best tuning factors for any given set point for any recipe he chooses to cook/heat and control. This results in optimal control for a wide range of temperature setpoints as shown in FIG. 2.

The invention consists of a hardware temperature controller 20 connected to a computer 25 by means of a network including a USB cable 50. The controller will have a power source such as a cord 55.

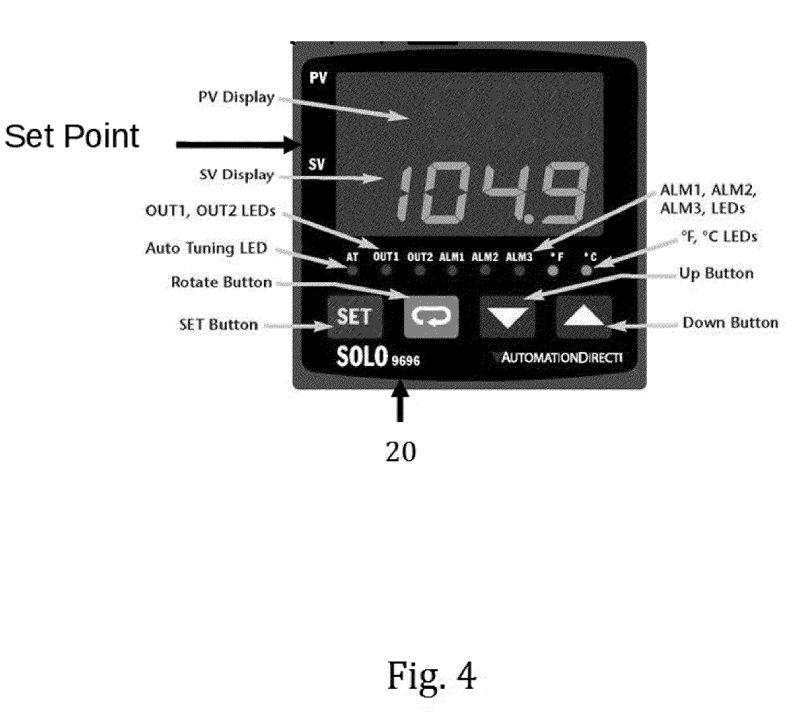

The Temperature Controller 20 includes a temperature sensing device whose probe end 40 is re-locatable and is placed in a cooker/heating vessel 100 and constantly measures the temperature of the food or liquid product in the cooker 100. The probe 40 is connected to the PID controller 20 either through a standard cable or it can use wireless communication. The PID controller 20 includes a dual display for displaying Temperature set point and actual temperature as shown in FIG. 4. It will have a set button and temperature adjustment button such as up and down arrows. It will have PV and SV displays as well as various LED such as auto tuning, ALM1, ALM2, ALM3 and Fahrenheit/Celsius.

Below are two modes for reaching a desired temperature to assist the user in Traditional and user during Tradition Sous Vide cooking using PID control 20.

1) Time-Priority Control-Timer is activated when User begins cooking and heat is applied

2) Temperature-Priority Control-Timer is activated after user begins cooking, but no heat is applied to the food until the Temperature measured, crosses over the Temperature set point.

The invention allows the user to select Time Priority or Temperature Priority Control, giving the User flexibility in controlling how the food or an experiment reaches a given temperature and then how long the food or experiment is cooked at that temperature. For example if the Sous Vide recipe calls for cooking Chicken at 140 F for 2 hours and the cooker 100 takes 30 minutes to reach 140 F from an ambient temperature of 70 F, then with PID and a timer set to 2 hours using; Time-Priority Control; the user would only be cooking the chicken at somewhere between 70 F and 140 F for 30 minutes and then cooking the chicken exactly at 140 F for another 1 hour and 30 mins.

For the same scenario, but using this timer with Temperature-Priority Control, the user would be cooking the chicken for 2 hours and 30 mins, which from a food safety viewpoint is better.

Sous Vide equipment vendors who don't have a Temperature-Priority Control feature, require the User to Pre-Heat the water in the cooker 100 to a specific Cooking temperature at which time the User starts the cooking timer to ensure that the particular food is cooked for a specific temperature and a specific time period. The pre-heating of the water thus approximates a Temperature Priority system, since it is assuring the temperature is at the actual cooking temperature prior to placing the food in the water bath. Pre-Heating is less often used in Traditional Cooking However if the user wants to Sous Vide a Food that has been previously frozen, then the Temperature Priority Control feature facilitates that requirement.

PID Controllers 20 generally do not have Time or Temperature Priority Control features built in. so in Gourmet Maestro these Control Modes can be achieved by the software 10. Gourmet Maestro Software implements Temperature Priority Control; by continually measuring the Temperature when the cooking starts. Since it knows when the Target Temperature is reached, the Temperature Priority Control algorithm will then turn on the Software Timer and begin timing the cooking recipe from this point, guaranteeing a cooking time of exactly 2 hours at 140 F for the chicken recipe.

The system in very novel as it has a relocatable probe 40 with a wide temperature sensing range that allows the probe 40 to be placed in a cheap slow cooker 100 which turns it into a highly accurate SOUS Vide Low temperature Long time Cooker. The probe 40 can also be placed inside a convection toaster oven for regular cooking and again convert notoriously inaccurate ovens into a precise temperature controlled Cooking device 100 which can precisely control temperature, making the convection Oven more accurate for general cooking and allowing Hot Air Sous Vide type Cooking without placing the food in plastic bags and removing the air inside the bag which is required for Hot water Sous Vide Cooking. This process is Hot air ne sous Vide pas, which indicates using Hot air cooking at low temperatures and for a long time while the food is not in plastic bags under a vacuum.

One method that the system can use to control the temperature is use of controlling the power to the cooker through a power controller or control 30.

The invention includes the ability for Gourmet Maestro or the User to calibrate the temperature sensor for more than 21 (variable temperature points) covering the normal range and higher; of Low temperature Long time (Sous Vide) cooking, which falls in the range from 100 Deg F. to 185 Deg F. Each will use the Calibrated temperatures of: 100 F; 105 F, 110 F, 115 F, 120 F, 125 F, 130 F, 131 F, 135 F, 140 F 145 F, 158 F, 160 F, 165 F, 170 F, 175 F, 180 F, 185 F, 190 F, 195 F, 200 F. The invention's software calibration algorithm will allow the User to enter in the preferred embodiment, up to 21 temperatures which are close to the above values. The user then uses a scientifically calibrated thermometer to accurately measure the actual temperature for each of his entries, and enters the correct Temperature values into the computer and the software automatically calculates the offset and creates 20 linear equations of measured temperature vs. correct temperature. This calibration process will use linear regression analysis to create a more accurate temperature curve which is used to dynamically offset the temperature reading by an amount determined by the particular equation for which the temperature reading falls within. Thus for any measured temperature the software will change the contents of tPoF (Offset Field) which will add or subtract the calculated offset amount to the measured temperature, creating a final corrected temperature which will be used to display and control the cooking process. This procedure assures the system that the PID Controller will provide the most accurate temperature for control over a given range of temperatures.

The program will use linear regression to obtain the curve. The user is allowed to use more than 21 points which will provide accuracy over a wider temperature range.

The calibration option will function as follows:

1—The manual control should be selected and the user can modify manually the temperature. The user will also select the sensor type.

2—The user modifies the output manually and records the temperature of the sensor.

3—The user measures with the actual thermometer with a Certified Calibrated Thermometer and records the temperature of the thermometer.

4—The points 2 and 3 are repeated for others temperatures (21 or more).

5—When the user finishes with the temperatures, he press a button which executes the linear regression to get the coefficients of the linear equation.

6—A new file in the database will be created, for example calibrate.dat file which will be saved and contain: the type of sensor, the temperatures of the point 2,3 and the coefficients of the linear equation.

When a recipe is selected a calibrate.dat file for the sensor selected will be used by the program which will use the equation of the linear approximation. This calibration Process dynamically change the content of tPoF in real time according to temperature of the controller and the value of the calculation of the linear equation.

Sous Vide cooks often cook foods for up to 48 hours and of course the long times are unattended and Food experts like to observe how accurately they can control Pv over these long periods and to observe the deviation of Cooking temperature over time. The above feature will allow the user to watch for these deviations of PV versus Set Point over these long periods of time. Some cooks videotape the entire 48 hour long recipe, and then play back this video at high speed to observe the control response and Temperature Deviations of the Controlled temperature over these long periods.

In one embodiment, the system would add a High Speed Playback of recorded Recipe Cooked temperature vs Time CSV files including 5×, 10×, 15×, 20×, 25×, 30×, 35×, 40×, 45×, 50×, 60× Also adding the PID Display to the playback window and use its Big displays of Cooking Temperature and Cooking Set Point to show these Playback values.

Integral Windup

The integral function Calculates and adds up (integrates) the area under the Temperature error vs. time curve. This integration process adds more output in addition to the output calculated by the proportional function to help in counteracting the error between Sv and Pv.

The Proportional Band is the temperature band above and below the set point where the controller is actually controlling the process; the output is normally at some level other than 0% or 0100%. The band is generally centered around the set point (on single output controls) causing the output to be at 50% when the set point and the temperature are equal.

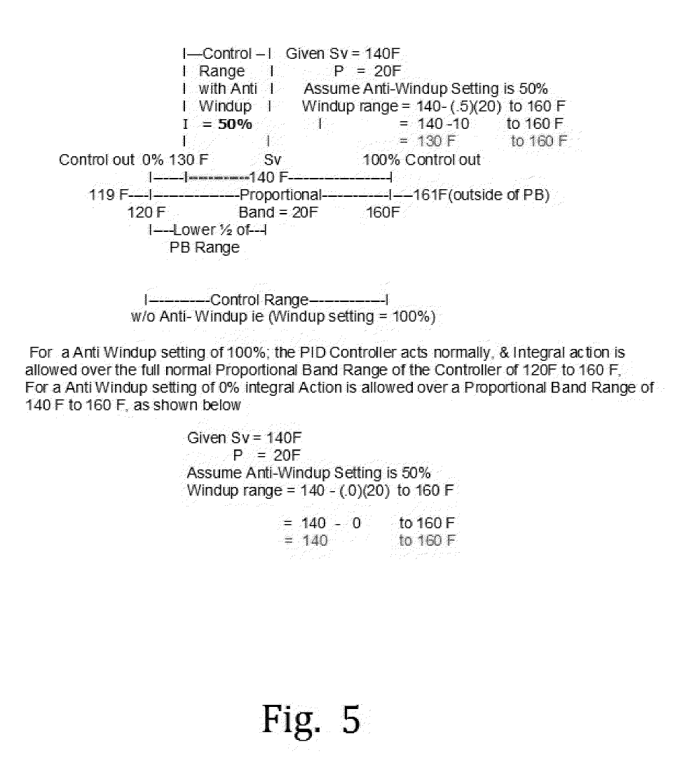

As shown in FIG. 5, for a Anti Windup setting of 100%; the PID Controller acts normally, & Integral action is allowed over the full normal Proportional Band Range of the Controller of 120 F to 160 F,

For a Anti Windup setting of 0% integral Action is allowed over a Proportional Band Range of 140 F to 160 F, as shown below:
Given Sv=140 F
   P=20 F
Assume Anti-Windup Setting is 50%

$$\begin{matrix}Windup range = 140 - ( .0 ) ( 20 ) to 160 F \\ = 140 - 0 to 160 F \\ = 140 to 160 F .\end{matrix}$$

When the temperature of a cooker is below the proportional band range (ex. 119 F) (during Ramp up), the proportional contribution will cause a 0% output. In this example the Integral Contribution will continue to look at the magnitude and the time duration of the error and the integral output function will continue to increase, in an attempt to make the final output greater than 0% which is not technically possible. Since the Output is already maxed down; the integral action grows in value but is not effective until the cooker temperature is within the Proportional band range. So the Integral action which is the area of the error curve keeps summing (Increasing) up internally within the controllers memory and winds up more and is remembered. So the integral term gets larger and larger (it winds up), and when the Set Point has been reached and the output from the proportional term will be zero, the integral term still remembers the value of the Integral Windup and continues to increase the controller output, resulting in temperature overshoot, and this increase will continue until the integral windup has been used up ie unwound.

Many PID-controllers shut off integral action as long as the temperature is outside the proportional band. This is called Anti -windup of the Integral Function. It's possible that integral windup can occur even at temperatures within the proportional band if the integral time (seconds per repeat) has been set to a very small time, which would result in stronger integral action and/or if derivative action contributes additional output during disturbance such as by adding food colder than the current temperature of the cooker

Gourmet Maestro software has a Anti-Windup Algorithm which limits integral control action to the upper range of the lower half of the Proportional Band, thus excluding the need to make tuning adjustments to the current tuning parameters.

For example, assume

SP=140° F.

P=20 F

Proportional band Range would be 120 F-160 F.

The Anti Windup value ranges from 0 to 100% and the User can vary this value via an entry in the Gourmet Maestro Use Interface.

With the Anti-Windup Value set to 100%, integral action would be allowed between the normal Proportional Band of the controller i.e. between 120 F and 160° F.

For the above example, with our Anti-windup Value set to 50%, integral action would be allowed only between 130 F and 160 F.

There is an advantage of reducing Anti-windup below 100%. The Gourmet maestro default setting for the Anti-Windup Function is 50%. This allows for strong integral and derivative settings for fast disturbance recovery, without having to accept overshoot after ramping up or after a user injects a load disturbance such as adding cold food.

The Integral tuning value (I)I may be adequate to compensate for control error, but could be too strong in response to a disturbance (temperature drop) and lead to overshoot and eventually oscillation. The normal solution would be to increase the value of I (Integral Time) which would make the integral contribution weaker.

So instead of Increasing the value of I, the user has the option to enter a Value between 0% and 100% in the Anti-Windup field in the Gourmet Maestro User Interface. Anti-Windup value below 100%, would confine the integration of the controller error to the upper range of the lower half of the proportional band. For example entering a Anti-Windup value of 50% to a controller whose P-band is 20 F and whose SP is 140 F; would allow integration of controller error only between 140 F−(50%)(20)=130 F to 160 F instead of the normal Proportional band Range of 120 F-160 F. So confining Integral control to the upper 50% of the lower half of the P band and to all of the upper half, should be sufficient to counteract disturbances without the help of the integral control function, but in the upper range of the P-band, the proportional function reduces output, so additional output power must be contributed by the integral function.

Advantages

The current invention allows the Chef/experimenter superior accuracy in controlling small to medium cooking and temperature experiment processes in small commercial or Home environments

The relocatability of the Gourmet Maestro temperature probe allows a User to drop-in the probe and convert inexpensive Rice Cookers, Slow Cookers, toaster ovens etc into Laboratory quality devices for managing recipe cooking or temperature experimentation.

The invention allows a Chef/Experimenter to control a cooking process in real-time and to visually monitor, graph and record the results for future analysis and allows the chef to manage and add to, an existing large recipe database which increases product quality and consistency.

The invention allows a working mom, College students and Millennials who are pressed for time, and computer literate, an affordable, reliable and consistent method of cooking recipes, while substantially reducing the time consuming references to cookbooks and similar media for recipe information.

The system allows cut/paste and modify so the above individuals can use/edit existing recipes as well as create and modify their existing recipes.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A device for the cooking of food comprising:
a software connected to a PID controller which is connected to a probe that is placed in a cooker that controls the cooking temperature based on specific data.

2. A device according to claim 1 further comprising:
Having a tuning table and heats the cooker to the 1st temperature in the tuning table and automatically upsets the process by changing the Set point, this response is observed from the response of the Temperature as a result of this upset and calculates the P,I & D tuning factors for that temperature set point and records theses values next to the temperature in the tuning table with the process heating the Cooker to the next temperature in the tuning table and repeats the calculations.

3. A device according to claim 1 further comprising:
controlling the temperature through the controlling of the power to the cooker through a power controller.

4. A device according to claim 1 further comprising:
Where the PID controller includes a dual display for displaying Temperature set point and actual temperature.

5. A device according to claim 1 further comprising:
Where the PID controller includes one or more of a dual display for displaying Temperature set point and actual temperature, a set button and temperature adjustment, PV, SV, auto tuning, ALM1, ALM2, ALM3 and Fahrenheit/Celsius displays.

6. A device according to claim 1 further comprising:
Probe is connected to the PID controller through a wireless communication.

7. A device according to claim 1 further comprising:
the software having an Anti-Windup Algorithm which limits integral control action to the upper range of the lower half of a Proportional Band.
